(19) United States
(12) Patent Application Publication
(10) Pub. No.: US 2026/0362100 A1
(43) Pub. Date: Nov. 12, 2026

(54) SWITCHING PROTOCOL FOR SELF-INITIATED MULTI-ANTENNA SWITCHED BISTATIC WIRELESS SENSING

(71) Applicant: GM Global Technology Operations LLC, Detroit, MI (US)

(72) Inventors: Kamran Ali, Troy, MI (US); Linsheng Zhang, Warren, MI (US)

(73) Assignee: GM Global Technology Operations LLC, Detroit, MI (US)

(21) Appl. No.: 19/205,872

(22) Filed: May 12, 2025

(51) Int. Cl. H04W 4/38; H04B 7/06; H04W 4/40

(52) U.S. Cl. CPC H04W 4/38; H04B 7/0604; H04W 4/40

(57) ABSTRACT

A method for performing wireless sensing in a vehicle between a first sensing device and a second sensing device. The method includes activating a first antenna configuration of the plurality of antenna configurations. Based on a frequency of an activity to be sensed and a number of antenna configurations in the plurality of antenna configurations, determining a maximum sensing cycle for each antenna configuration of the plurality of antenna configurations. The method includes transmitting, from the first antenna configuration, a sensing request signal to the second sensing device. The method includes determining expiration of the maximum sensing cycle for the first antenna configuration prior to receiving a response signal corresponding to the sensing request signal. Based on determining expiration of the maximum sensing cycle, the method includes switching activation from the first antenna configuration to a second antenna configuration of the plurality of antenna configurations.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to performing wireless sensing, for example, in a vehicle environment. Wireless communication devices may be equipped with multiple antennas. These antennas can be utilized to establish communication links, and the characteristics of the radio frequency signals propagating between devices via these links may change based on the surrounding environment, including the presence or movement of objects or persons. Techniques exist for utilizing multiple antennas simultaneously in communication systems, such as Multiple-Input Multiple-Output (MIMO) configurations, often employed to enhance data throughput or link robustness. Systems may also utilize antennas individually or in subsets, potentially activating different antennas or antenna configurations sequentially over time for communication or other purposes. Information about the environment may be obtained by analyzing properties of the wireless signals exchanged between devices during operation, such as measured channel characteristics like Channel State Information (CSI), which reflects the conditions of the propagation path between transmitting and receiving antennas.

### SUMMARY

One aspect of the disclosure provides a computer-implemented method for performing wireless sensing in a vehicle between a first sensing device and a second sensing device. The method is executed by data processing hardware that causes the data processing hardware to perform operations. The operations include activating a first antenna configuration of the plurality of antenna configurations and determining a maximum sensing cycle for each antenna configuration of the plurality of antenna configurations based on a frequency of an activity to be sensed and a number of antenna configurations in the plurality of antenna configurations. The operations include transmitting, from the first antenna configuration, a first sensing request signal to the second sensing device. The operations include receiving a first response signal from the second sensing device corresponding to the first sensing request signal and determining that the first response signal was received before an expiration of the maximum sensing cycle for the first antenna configuration. Based on determining that the first response signal was received before the expiration of the maximum sensing cycle for the first antenna configuration, the operations include switching activation from the first antenna configuration to a second antenna configuration of the plurality of antenna configurations. The operations include transmitting, from the second antenna configuration, a second sensing request signal to the second sensing device and determining expiration of the maximum sensing cycle for the second antenna configuration prior to receiving a second response signal corresponding to the second sensing request signal. Based on determining expiration of the maximum sensing cycle for the second antenna configuration prior to receiving the second response signal corresponding to the second sensing request signal, the operations include switching activation from the second antenna configuration to a third antenna configuration of the plurality of antenna configurations prior to receiving the second response signal.

Implementations of the disclosure may include one or more of the following optional features. In some implementations, the operations further include sensing a change in an environment between the first sensing device and the second sensing device based on the first response signal, the environment corresponding to an interior of the vehicle. In these implementations, the operations further include instructing the vehicle to perform an action based on sensing the change in the environment between the first sensing device and the second sensing device. Switching activation from the first antenna configuration to the second antenna configuration may occur prior to the expiration of the maximum sensing cycle for the first antenna configuration. In some examples, the operations further include after switching activation from the second antenna configuration to the third antenna configuration, receiving the second response signal from the second sensing device corresponding to the second sensing request signal and discarding the second response signal based on determining expiration of the maximum sensing cycle for the second antenna configuration prior to receiving the second response signal. In these examples, the second response signal may be received prior to the third antenna configuration transmitting a third sensing request signal to the second sensing device.

The maximum sensing cycle for each antenna configuration in the plurality of antenna configurations may be the same as the maximum sensing cycle for each other antenna configuration in the plurality of antenna configurations. In some implementations, the second sensing device comprises a plurality of antenna configurations and determining the maximum sensing cycle for each antenna configuration of the plurality of antenna configurations is further based on a number of antenna configurations in the plurality of antenna configurations of the second sensing device. The first antenna configuration may include a single antenna. The first antenna configuration may include two or more antennas.

Another aspect of the disclosure provides a vehicle that includes data processing hardware, a first sensing device in communication with the data processing hardware, a second sensing device in communication with the data processing hardware, and memory hardware in communication with the data processing hardware. The memory hardware stores instructions that when executed on the data processing hardware cause the data processing hardware to perform operations. The operations include activating a first antenna configuration of the plurality of antenna configurations and determining a maximum sensing cycle for each antenna configuration of the plurality of antenna configurations based on a frequency of an activity to be sensed and a number of antenna configurations in the plurality of antenna configurations. The operations include transmitting, from the first antenna configuration, a first sensing request signal to the second sensing device. The operations include receiving a first response signal from the second sensing device corresponding to the first sensing request signal and determining that the first response signal was received before an expiration of the maximum sensing cycle for the first antenna configuration. Based on determining that the first response signal was received before the expiration of the maximum sensing cycle for the second antenna configuration, the operations include switching activation from the first antenna configuration to a second antenna configuration of the plurality of antenna configurations. The operations include transmitting, from the second antenna configuration, a second sensing request signal to the second sensing device and determining expiration of the maximum sensing cycle for the second antenna configuration prior to receiving a second response signal corresponding to the second sensing request signal. Based on determining expiration of the maximum sensing cycle for the second antenna configuration prior to receiving the second response signal corresponding to the second sensing request signal, the operations include switching activation from the second antenna configuration to a third antenna configuration of the plurality of antenna configurations prior to receiving the second response signal.

Implementations of the disclosure may include one or more of the following optional features. In some implementations, the operations further include sensing a change in an environment between the first sensing device and the second sensing device based on the first response signal, the environment corresponding to an interior of the vehicle. In these implementations, the operations further include instructing the vehicle to perform an action based on sensing the change in the environment between the first sensing device and the second sensing device. Switching activation from the first antenna configuration to the second antenna configuration may occur prior to the expiration of the maximum sensing cycle for the first antenna configuration. In some examples, the operations further include after switching activation from the second antenna configuration to the third antenna configuration, receiving the second response signal from the second sensing device corresponding to the second sensing request signal and discarding the second response signal based on determining expiration of the maximum sensing cycle for the second antenna configuration prior to receiving the second response signal. In these examples, the second response signal may be received prior to the third antenna configuration transmitting a third sensing request signal to the second sensing device.

The maximum sensing cycle for each antenna configuration in the plurality of antenna configurations may be the same as the maximum sensing cycle for each other antenna configuration in the plurality of antenna configurations. In some implementations, the second sensing device comprises a plurality of antenna configurations and determining the maximum sensing cycle for each antenna configuration of the plurality of antenna configurations is further based on a number of antenna configurations in the plurality of antenna configurations of the second sensing device. The first antenna configuration may include one or more antennas.

Another aspect of the disclosure provides a computer-implemented method for performing wireless sensing in a vehicle between a first sensing device and a second sensing device. The method is executed by data processing hardware that causes the data processing hardware to perform operations. The operations include activating a first antenna configuration of the plurality of antenna configurations. Based on a frequency of an activity to be sensed and a number of antenna configurations in the plurality of antenna configurations, the operations include determining a maximum sensing cycle for each antenna configuration of the plurality of antenna configurations. The operations include transmitting, from the first antenna configuration, a sensing request signal to the second sensing device and determining expiration of the maximum sensing cycle for the first antenna configuration prior to receiving a response signal corresponding to the sensing request signal. The operations include switching activation from the first antenna configuration to a second antenna configuration of the plurality of antenna configurations prior to receiving the response signal based on determining expiration of the maximum sensing cycle for the first antenna configuration prior to receiving the response signal corresponding to the sensing request signal.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for wireless sensing in a vehicle.

FIG. 2 is a schematic view of an example switching process of the system in FIG. 1.

FIG. 3 is a flowchart of an example arrangement of operations for performing wireless sensing between a first sensing device and a second sensing device.

FIG. 4 is a flowchart of an example arrangement of operations for performing wireless sensing between a first sensing device and a second sensing device.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

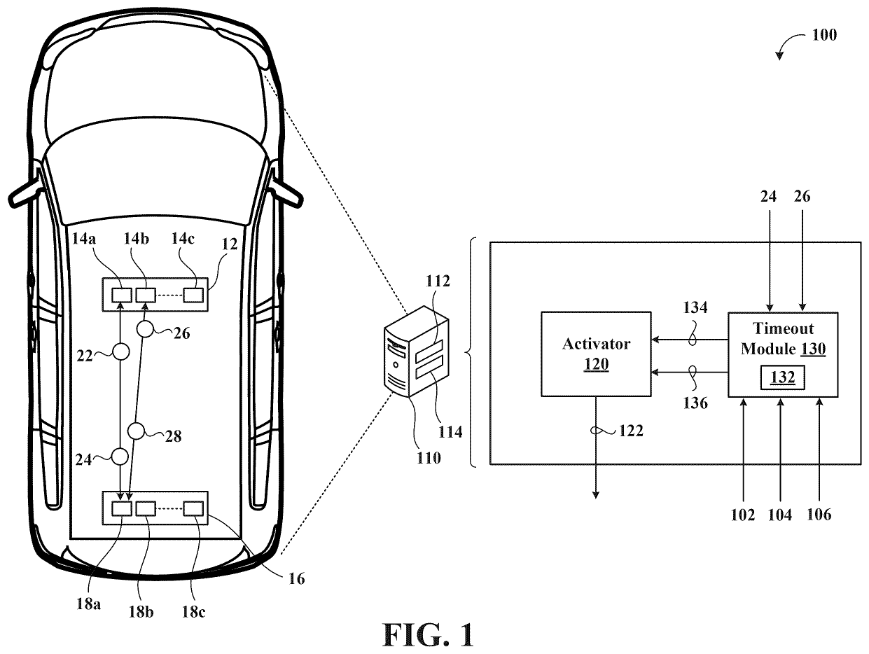

Referring to FIG. 1, in some implementations, a system 100 leverages communication devices for sensing applications. The system 100 includes a controller 110 that may be implemented within a vehicle 10, but the disclosure herein may apply to other environments, such as home security or presence detection. The controller 110 may operate using established wireless communication protocols, such as Wi-Fi or Ultra-Wideband (UWB), although the system is protocol-agnostic and may be applied to future communication technologies. The controller 110 may use bistatic sensing or multi-static sensing. Bistatic sensing involves two devices at different locations, one transmitting and one receiving (though roles may be reciprocal), to sense the environment between the devices. Multi-static sensing extends this concept to involve multiple transmitters and/or receivers. The controller 110 includes data processing hardware 112 and memory hardware 114 in communication with the data processing hardware 112. The memory hardware 114 stores instructions that when executed on the data processing hardware 112 cause the data processing hardware 112 to perform operations. Unlike traditional Multiple-Input Multiple-Output (MIMO) systems where signals from multiple antennas are typically processed simultaneously requiring significant computational resources, the system 100 focuses on switching between antennas or antenna configurations sequentially or in subsets, offering a more cost-effective and computational efficient approach by reducing the need for parallel processing. However, in some examples, a subset of antenna configurations operate in a MIMO mode.

In the example shown, the vehicle 10 includes a first sensing device 12 and a second sensing device 16. In other examples, more than two sensing devices may be used. The first sensing device 12 and the second sensing device 16 are each in communication with the data processing hardware 112. In this example, the first sensing device 12 acts as a primary sensor or “requestor” and the second sensing device 16 acts as a “responder.” However, these roles are not fixed as the second sensing device 16 may act as the “requestor” and the first sensing device 12 may act as the “responder” in subsequent cycles. The controller 110 may sense the environment based on information derived from these exchanged signals, such as Channel State Information (CSI) or Channel Impulse Response (CIR), which characterizes how the signal travels between the first sensing device 12 and the second sensing device 16. Changes in the environment, such as movement or breathing, alter the CSI, allowing detection.

The first sensing device 12 has a plurality of antenna configurations 14. For example, the first sensing device 12 may have a plurality of small antennas aimed at different zones within the interior of the vehicle 10 (e.g., driver seat, passenger seat, rear seats) to provide targeted sensing coverage. In some examples, each antenna configuration 14 includes a single antenna. In other examples, each antenna configuration 14 has two or more antennas operating in a localized MIMO fashion, rather than requiring activation of only one antenna at a time. That is, a subset of antenna configurations 14 may operate in a MIMO mode. Similarly, the second sensing device 16 may also have a plurality of antenna configurations 18 whereby each antenna configuration 18 may have one or more antennas. The second sensing device may be an existing vehicle communication module, for example a Wi-Fi hotspot. In the example shown, the first sensing device 12 has three antenna configurations 14, 14a-c and the second sensing device 16 has three antenna configurations 18, 18a-c for the sake of clarity only, as it is understood that the plurality of first antenna configurations 14 and the plurality of second antenna configurations 18 may have any number of configurations. The controller 110 may be integrated with the first sensing device 12 or the second sensing device 16, or be a separate entity integrated within the vehicle 10.

The controller 110 includes an activator 120 and a timeout module 130. The activator 120 activates a first antenna configuration 14, 14a of the plurality of antenna configurations 14 of the first sensing device 12. The first antenna configuration 14a may include a single antenna located on a b-pillar of the vehicle 10. The timeout module 130 determines a maximum sensing cycle 132 for each antenna configuration 14 of the plurality of antenna configurations 14 based on a frequency 102 of an activity to be sensed and a number of antenna configurations 104 in the plurality of antenna configurations 14 of the first sensing device 12. In some examples, the timeout module 130 determines the maximum sensing cycle 132 further based on a number of antenna configurations 106 in the plurality of antenna configurations 18 of the second sensing device 16. The frequency 102 may be predetermined based on the activity to be sensed.

The maximum sensing cycle 132 represents the time budget allocated to this specific antenna configuration within the overall constraints imposed by the Nyquist sampling theorem for the activity being monitored. The maximum sensing cycle 132 may also be referred to as a Nyquist timeout value. The timeout module 130 may determine the maximum sensing cycle 132 based on the Nyquist sampling theorem applied to the frequency 102 of the activity to be sensed and the total number of antenna configurations 104 in the plurality of antenna configurations 14. For instance, if the activity is detecting the subtle chest movements of breathing, which may occur at the frequency 102 of 0.5 Hz (e.g., 30 breaths per minute), the Nyquist theorem suggests sampling at least twice the frequency 102 (e.g., 1 Hz, or once per second). Here, if the controller 110 cycles through N=4 different antenna configurations 14, then the total cycle time for all 4 antenna configurations 14 may be less than or equal to one second. In some examples, the maximum sensing cycle 132 for each antenna configuration 14 in the plurality of antenna configurations 14 is the same as the maximum sensing cycle 132 for each other antenna configuration 14 in the plurality of antenna configurations 14. In some configurations, the maximum sensing cycle 132 applies for each antenna configuration 18 in the second sensing device 16 if the second sensing device 16 also cycles through antennas.

The sensing process involves exchanging wireless signals between the currently active antenna configuration 14 of the first sensing device 12 and the second sensing device 16 to sense the environment. The activator 120 generates instructions 122 that cause the currently active first antenna configuration 14a of the first sensing device 12 to transmit to the second sensing device 16 a first sensing request signal 22. The first sensing request signal 22, when received by the second sensing device 16, causes the second sensing device 16 to send a first response signal 24. The first response signal 24 may include information, such as channel state information (CSI), which is affected by the environment between the first antenna configuration 14a and the second sensing device 16. The timeout module 130 monitors for the first response signal 24 from the second sensing device 16 corresponding to the first sensing request signal 22.

The timeout module 130 determines whether the first response signal 24 was received before an expiration of the maximum sensing cycle 132 for the first antenna configuration 14a. If the timeout module 130 determines that the first response signal 24 was received before the expiration of the maximum sensing cycle 132 for the first antenna configuration 14a, the timeout module 130 generates first instructions 134 indicating that the maximum sensing cycle 132 has expired. Based on receiving the first instructions 134, the activator 120 switches activation (i.e., relinquishes control) from the first antenna configuration 14a to a second antenna configuration 14, 14b of the plurality of antenna configurations 14. Notably, the controller 110 switches activation from the first antenna configuration 14a to the second antenna configuration 14b in response to receiving the first instructions 134 which occurs prior to the expiration of the maximum sensing cycle 132 for the first antenna configuration 14a However, due to the nature of wireless communication, especially in asynchronous systems where devices lack perfect synchronization and may face channel contention, interference, or signal delays, responses may not always arrive within the calculated time.

After switching activation to the second antenna configuration 14b, the controller 110 transmits, from the second antenna configuration 14b, a second sensing request signal 26 to the second sensing device 16. The controller 110 then waits for the corresponding response but simultaneously monitors the elapsed time against the timeout. In some examples, the controller 110 determines expiration of the maximum sensing cycle 132 for the second antenna configuration 14b prior to receiving a second response signal 28 corresponding to the second sensing request signal 26. The expiration indicates that the allowed time budget for this specific sensing state has been exhausted without receiving the expected response. Notably, to maintain the overall Nyquist sampling rate for the sensing activity across the full sequence of antenna configurations 14, the controller 110 switches activation (i.e., relinquishes control) from the second antenna configuration 14b to a third antenna configuration 14, 14c. That is, the controller 110 switches activation from the second antenna configuration 14b to the third antenna configuration 14c of the plurality of antenna configurations 14 prior to receiving the second response signal 28 based on determining expiration of the maximum sensing cycle 132 for the second antenna configuration 14b prior to receiving the second response signal 28 corresponding to the second sensing request signal 26. The timeout module 130 may generate second instructions 136 indicating that the maximum sensing cycle 132 has expired. Based on receiving the second instructions 136, the activator 120 switches activation (i.e., relinquishes control) from the second antenna configuration 14b to the third antenna configuration 14c of the plurality of antenna configurations 14. The third antenna configuration 14c may correspond to the first antenna configuration 14a or a different antenna configuration 14 than the first antenna configuration 14a and the second antenna configuration 14b. That is, the controller 110 may continuously switch between the first antenna configuration 14a and the second antenna configuration 14b or continuously switch between any number of antenna configurations 14.

Subsequently, after switching activation from the second antenna configuration 14b to the third antenna configuration 14c due to the timeout, the controller 110 may receive the second response signal 128 from the second sensing device 16 corresponding to the second sensing request signal 26. Thus, the controller 110 discards the second response signal 28 based on determining the expiration of the maximum sensing cycle 132 for the second antenna configuration 14b prior to receiving the second response signal 28. Moreover, the second response signal 28 may be received prior to the third antenna configuration 14c transmitting a subsequent sensing request signal to the second sensing device 16. As such, the controller 110 may determine that the second response signal 28 corresponds to the second sensing request signal 26 because the third antenna configuration 14c, which is now active, has not transmitted the subsequent sensing request signal yet. In some examples, the second response signal 28 may include a tag or identifier indicating that the second response signal 28 was intended for the second antenna configuration 14b, allowing the controller 110 to ignore or correctly identify and discard the second response signal 28.

The controller 110 may sense a change in an environment between the first sensing device 12 and the second sensing device 16 based on the first response signal 24 and any other response signals received within the maximum sensing cycle 132. For instance, if the system 100 is in the vehicle, the environment may correspond to an interior of the vehicle 10, whereby the change represents a sign of life within the vehicle (e.g., breathing of a child or pet left behind) or unauthorized intrusion. Accordingly, the controller may instruct the vehicle to perform an action based on sensing the change in the environment between the first sensing device 12 and the second sensing device 16 such as activating climate control, sounding an alarm, or sending a notification to the owner. Moreover, the controller 110 may monitor the sensing process for errors. For example, if responses for a particular antenna configuration 14 are consistently late or missing (i.e., frequently exceeding the maximum sensing cycle 132), the controller 110 may log this issue, determine that sensing coverage for the corresponding zone is compromised (e.g., due to blockage or interference), and optionally notify the user or driver (e.g., via an indicator light or a message on the dashboard display) that the performance of the system may be degraded in that area or overall due to persistent high interference levels.

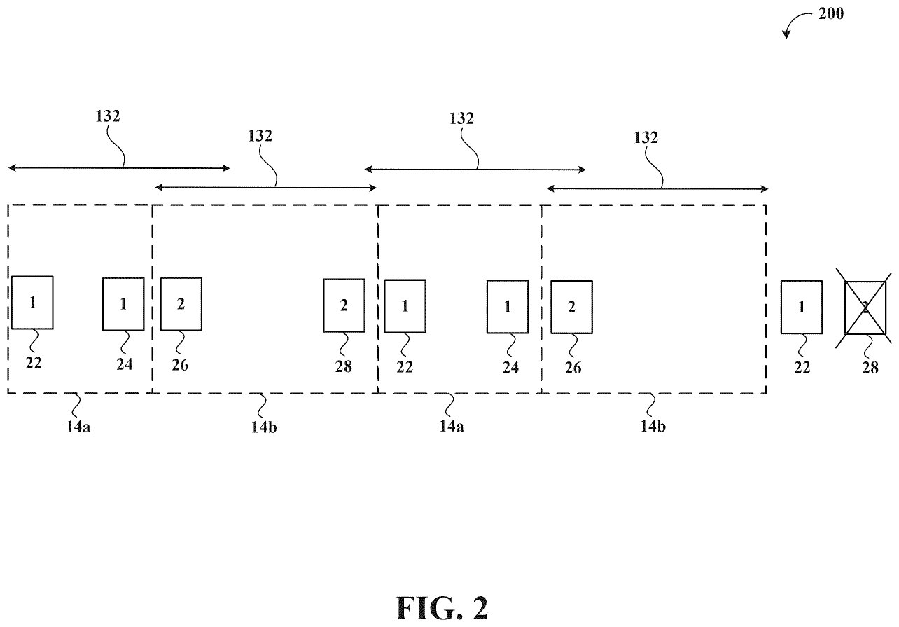

FIG. 2 illustrates an example switching process 200 employed by the system 100 (FIG. 1). In the example shown, the switching process 200 involves two antenna configurations 14a, 14b of the first sensing device 12 and a single antenna configuration 18 of the second sensing device 16. Here, the first antenna configuration 14a sends a first sensing request signal 22 to the second sensing device 16 and receives the first response signal 24 within the maximum sensing cycle 132. As such, the controller 110 switches activation from the first antenna configuration 14a to the second antenna configuration 14b based on receiving the first response signal 24. Notably, the switching occurs before the expiration of the maximum sensing cycle 132 of the first antenna configuration 14a, which initiates the maximum sensing cycle 132 of the second antenna configuration 14b. Similarly, the second antenna configuration 14b sends a second sensing request signal 26 to the second sensing device 16 and receives the second response signal 28 within the maximum sensing cycle 132. As such, the controller 110 switches activation from the second antenna configuration 14b back to the first antenna configuration 14a based on receiving the second response signal 28. Here, the controller 110 switches activation from the second antenna configuration 14b back to the first antenna configuration 14a at or before the expiration of the maximum sensing cycle 132.

With continued reference to FIG. 2, the first antenna configuration 14a again sends the first sensing request signal 22 to the second sensing device 16 and receives the first response signal 24 within the maximum sensing cycle 132 such that the controller switches activation from the first antenna configuration 14a back to the second antenna configuration 14b based on receiving the first response signal 24. The second antenna configuration 14b again sends the second sensing request signal 26 to the second sensing device 16 and receives the second response signal 28. In this scenario, the second response signal 28 is received after the expiration of the maximum sensing cycle 132 such that the controller 110 switches activation back to the first antenna configuration 14a before receiving the second response signal 28. Thus, the second response signal 28 is received after the first antenna configuration 14a is active (and the second antenna configuration 14b is deactivated) such that the controller 110 discards the second response signal 28 (e.g., denoted by the “X” on the second response signal 28).

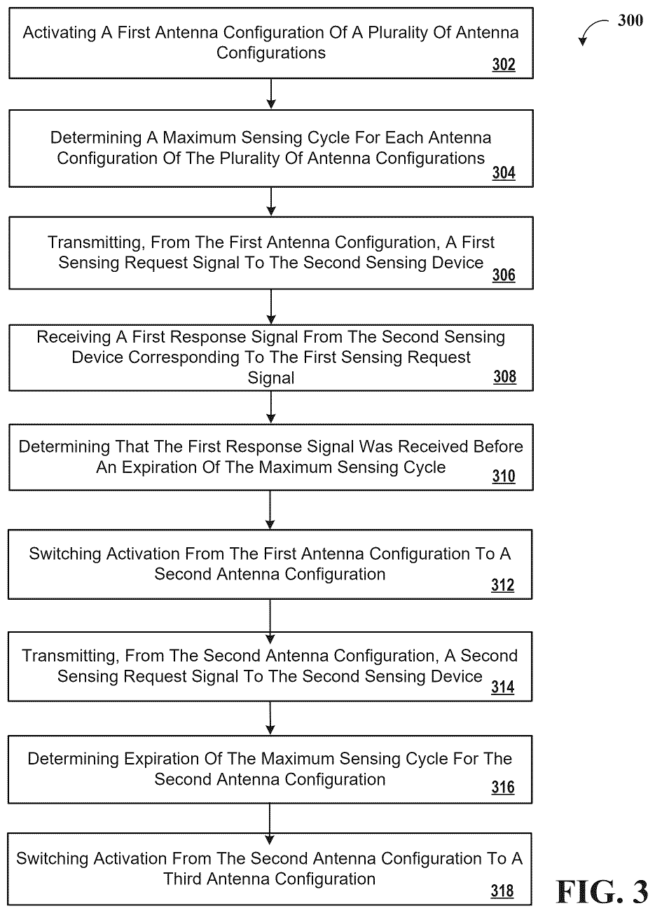

FIG. 3 includes a flowchart of an example arrangement of operations for a method 300 of performing wireless sensing in the vehicle 10 between the first sensing device 12 and the second sensing device 16. The method 300 may be described with reference to FIGS. 1 and 2. The data processing hardware 112 may execute instructions stored on memory hardware 114 to perform the example arrangement of operation for the method 300.

At operation 302, the method 300 includes activating a first antenna configuration 14a of the plurality of antenna configurations 14. At operation 304, the method 300 includes determining, based on a frequency 102 of an activity to be sensed and a number of antenna configurations 104 in the plurality of antenna configurations 14, a maximum sensing cycle 132 for each antenna configuration 14 of the plurality of antenna configurations 14. At operation 306, the method 300 includes transmitting, from the first antenna configuration 14a, a first sensing request signal 22 to the second sensing device 16. At operation 308, the method 300 includes receiving a first response signal 24 from the second sensing device 16 corresponding to the first sensing request signal 22. At operation 310, the method 300 includes determining that the first response signal 24 was received before an expiration of the maximum sensing cycle 132 for the first antenna configuration 14a.

At operation 312, the method 300 includes switching activation from the first antenna configuration 14a to a second antenna configuration 14b of the plurality of antenna configurations 14 based on determining that the first response signal 24 was received before the expiration of the maximum sensing cycle 132 for the first antenna configuration 14a. At operation 314, the method 300 includes transmitting, from the second antenna configuration 14b, a second sensing request signal 26 to the second sensing device 16. At operation 316, the method 300 includes determining expiration of the maximum sensing cycle 132 for the second antenna configuration 14b prior to receiving a second response signal 28 corresponding to the second sensing request signal 26. At operation 318, the method 300 includes switching activation from the second antenna configuration 14b to a third antenna configuration 14c of the plurality of antenna configurations 14 prior to receiving the second response signal 28.

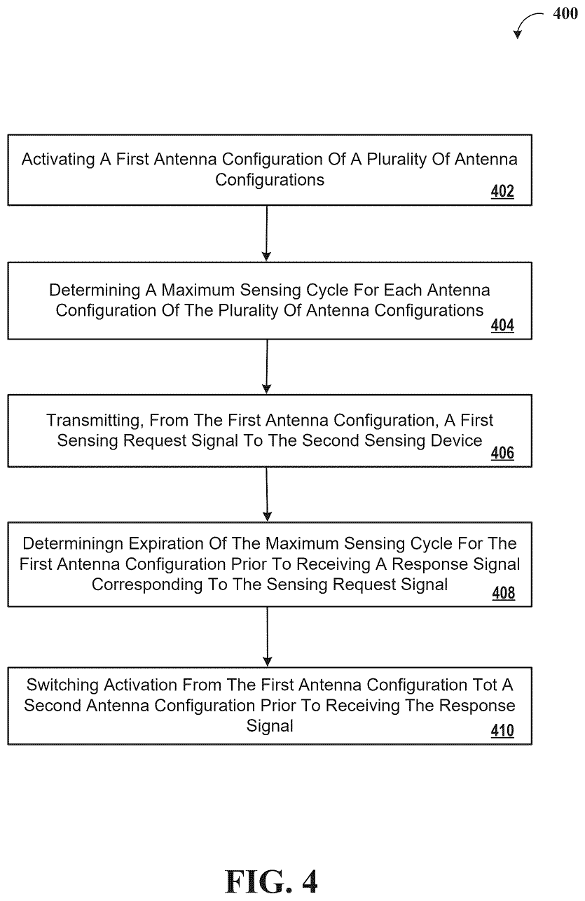

FIG. 4 includes a flowchart of an example arrangement of operations for a method 400 of performing wireless sensing in a vehicle between the first sensing device 12 and the second sensing device 16. The method 400 may be described with reference to FIGS. 1 and 2. The data processing hardware 112 may execute instructions stored on memory hardware 114 to perform the example arrangement of operation for the method 400.

At operation 402, the method 400 includes activating a first antenna configuration 14a of the plurality of antenna configurations 14. At operation 404, the method 400 includes determining, based on a frequency 102 of an activity to be sensed and a number of antenna configurations 104 in the plurality of antenna configurations 14, a maximum sensing cycle 132 for each antenna configuration 14 of the plurality of antenna configurations 14. At operation 406, the method 400 includes transmitting, from the first antenna configuration 14a, a sensing request signal 22 to the second sensing device 16. At operation 408, the method 400 includes determining expiration of the maximum sensing cycle 132 for the first antenna configuration 14a prior to receiving a response signal 24 corresponding to the sensing request signal 22. At operation 410, the method 400 includes switching activation from the first antenna configuration 14a to a second antenna configuration 14b of the plurality of antenna configurations 14 prior to receiving the first response signal 24 based on determining the expiration of the maximum sensing cycle 132 for the first antenna configuration 14a prior to receiving the response signal 24 corresponding to the sensing request signal 22.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method for performing wireless sensing in a vehicle between a first sensing device and a second sensing device, the method executed by data processing hardware that causes the data processing hardware to perform operations comprising:
activating a first antenna configuration of a plurality of antenna configurations;
determining, based on a frequency of an activity to be sensed and a number of antenna configurations in the plurality of antenna configurations, a maximum sensing cycle for each antenna configuration of the plurality of antenna configurations;
transmitting, from the first antenna configuration, a first sensing request signal to the second sensing device;
receiving a first response signal from the second sensing device corresponding to the first sensing request signal;
determining that the first response signal was received before an expiration of the maximum sensing cycle for the first antenna configuration;
based on determining that the first response signal was received before the expiration of the maximum sensing cycle for the first antenna configuration, switching activation from the first antenna configuration to a second antenna configuration of the plurality of antenna configurations;
transmitting, from the second antenna configuration, a second sensing request signal to the second sensing device;
determining expiration of the maximum sensing cycle for the second antenna configuration prior to receiving a second response signal corresponding to the second sensing request signal; and
based on determining the expiration of the maximum sensing cycle for the second antenna configuration prior to receiving the second response signal corresponding to the second sensing request signal, switching activation from the second antenna configuration to a third antenna configuration of the plurality of antenna configurations prior to receiving the second response signal.

2. The method of claim 1, wherein the operations further comprise sensing a change in an environment between the first sensing device and the second sensing device based on the first response signal, the environment corresponding to an interior of the vehicle.

3. The method of claim 2, wherein the operations further comprise instructing the vehicle to perform an action based on sensing the change in the environment between the first sensing device and the second sensing device.

4. The method of claim 1, wherein switching activation from the first antenna configuration to the second antenna configuration occurs prior to the expiration of the maximum sensing cycle for the first antenna configuration.

5. The method of claim 1, wherein the operations further comprise:
after switching activation from the second antenna configuration to the third antenna configuration, receiving the second response signal from the second sensing device corresponding to the second sensing request signal; and
discarding the second response signal based on determining expiration of the maximum sensing cycle for the second antenna configuration prior to receiving the second response signal.

6. The method of claim 5, wherein the second response signal is received prior to the third antenna configuration transmitting a third sensing request signal to the second sensing device.

7. The method of claim 1, wherein the maximum sensing cycle for each antenna configuration in the plurality of antenna configurations is the same as the maximum sensing cycle for each other antenna configuration in the plurality of antenna configurations.

8. The method of claim 1, wherein:
the second sensing device comprises a plurality of antenna configurations; and
determining the maximum sensing cycle for each antenna configuration of the plurality of antenna configurations is further based on a number of antenna configurations in the plurality of antenna configurations of the second sensing device.

9. The method of claim 1, wherein the first antenna configuration comprises a single antenna.

10. The method of claim 1, wherein the first antenna configuration comprises two or more antennas.

11. A vehicle comprising:
data processing hardware;
a first sensing device in communication with the data processing hardware;
a second sensing device in communication with the data processing hardware; and
memory hardware in communication with the data processing hardware, the memory hardware storing instructions that when executed on the data processing hardware cause the data processing hardware to perform operations comprising:
activating a first antenna configuration of a plurality of antenna configurations;
determining, based on a frequency of an activity to be sensed and a number of antenna configurations in the plurality of antenna configurations, a maximum sensing cycle for each antenna configuration of the plurality of antenna configurations;
transmitting, from the first antenna configuration, a first sensing request signal to the second sensing device;
receiving a first response signal from the second sensing device corresponding to the first sensing request signal;
determining that the first response signal was received before an expiration of the maximum sensing cycle for the first antenna configuration;
based on determining that the first response signal was received before the expiration of the maximum sensing cycle for the first antenna configuration, switching activation from the first antenna configuration to a second antenna configuration of the plurality of antenna configurations;
transmitting, from the second antenna configuration, a second sensing request signal to the second sensing device;
determining expiration of the maximum sensing cycle for the second antenna configuration prior to receiving a second response signal corresponding to the second sensing request signal; and
based on determining the expiration of the maximum sensing cycle for the second antenna configuration prior to receiving the second response signal corresponding to the second sensing request signal, switching activation from the second antenna configuration to a third antenna configuration of the plurality of antenna configurations prior to receiving the second response signal.

12. The vehicle of claim 11, wherein the operations further comprise sensing a change in an environment between the first sensing device and the second sensing device based on the first response signal, the environment corresponding to an interior of the vehicle.

13. The vehicle of claim 12, wherein the operations further comprise instructing the vehicle to perform an action based on sensing the change in the environment between the first sensing device and the second sensing device.

14. The vehicle of claim 11, wherein switching activation from the first antenna configuration to the second antenna configuration occurs prior to the expiration of the maximum sensing cycle for the first antenna configuration.

15. The vehicle of claim 11, wherein the operations further comprise:
after switching activation from the second antenna configuration to the third antenna configuration, receiving the second response signal from the second sensing device corresponding to the second sensing request signal; and
discarding the second response signal based on determining expiration of the maximum sensing cycle for the second antenna configuration prior to receiving the second response signal.

16. The vehicle of claim 15, wherein the second response signal is received prior to the third antenna configuration transmitting a third sensing request signal to the second sensing device.

17. The vehicle of claim 11, wherein the maximum sensing cycle for each antenna configuration in the plurality of antenna configurations is the same as the maximum sensing cycle for each other antenna configuration in the plurality of antenna configurations.

18. The vehicle of claim 11, wherein:
the second sensing device comprises a plurality of antenna configurations; and
determining the maximum sensing cycle for each antenna configuration of the plurality of antenna configurations is further based on a number of antenna configurations in the plurality of antenna configurations of the second sensing device.

19. The vehicle of claim 11, wherein the first antenna configuration comprises one or more antennas.

20. A computer-implemented method for performing wireless sensing in a vehicle between a first sensing device and a second sensing device, the method executed by data processing hardware that causes the data processing hardware to perform operations comprising:
activating a first antenna configuration of a plurality of antenna configurations;
determining, based on a frequency of an activity to be sensed and a number of antenna configurations in the plurality of antenna configurations, a maximum sensing cycle for each antenna configuration of the plurality of antenna configurations;
transmitting, from the first antenna configuration, a sensing request signal to the second sensing device;
determining expiration of the maximum sensing cycle for the first antenna configuration prior to receiving a response signal corresponding to the sensing request signal; and
based on determining the expiration of the maximum sensing cycle for the first antenna configuration prior to receiving the response signal corresponding to the first sensing request signal, switching activation from the first antenna configuration to a second antenna configuration of the plurality of antenna configurations prior to receiving the response signal.
